(19) United States
(12) Patent Application Publication
(10) Pub. No.: US 2008/0057163 A1
(43) Pub. Date: Mar. 6, 2008

(54) PACKAGED FLAVOR ENHANCED FOOD PRODUCTS

(76) Inventors: Andrew Kegler, Ripon, WI (US); Qingyue Ling, Tigard, OR (US); Galen D. Kaufman, Galveston, TX (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/852,140

(22) Filed: Sep. 7, 2007

Related U.S. Application Data
(63) Continuation-in-part of application No. 11/454,814, filed on Jun. 15, 2006.
Application No. 11/454,814 is a continuation-in-part of application No. 10/857,043, filed on May 28, 2004.
(60) Provisional application No. 60/843,064, filed on Sep. 7, 2006.
(60) Provisional application No. 60/699,460, filed on Jul. 15, 2005.

(51) Int. Cl. A23L 3/3418; B65D 85/00; B65D 85/34; B65D 85/78; B65D 85/80

(52) U.S. Cl. 426/129; 426/106; 426/130; 426/324

(57) ABSTRACT

Enhancing the flavor of food products within its product packaging to extend its shelf-life and to allow for mass production and mass distribution, and the packaged flavor enhanced food products produced. The method comprises providing product packaging capable of retaining a positive pressure of CO₂, receiving food products such as fruits or vegetables into the product packaging, introducing CO₂ into the product packaging, and sealing the product packaging containing the fruits or vegetables and CO₂, wherein the fruits or vegetables absorb CO₂ within the packaging thereby enhancing the flavor of the fruits or vegetables. The packaged flavor enhanced food products may comprise, for example, carbonated or “fizzed” fruit or vegetable pieces in yogurt, fruit or vegetable pieces in ice cream or sorbet, or other food items that may contain carbonated fruit or vegetable pieces, purees, sauces, or the like.

### CROSS-REFERENCE TO RELATED APPLICATIONS

This application claims the benefit of U.S. provisional patent application Ser. No. 60/843,064, filed Sep. 7, 2006, and is a continuation-in-part of U.S. patent application Ser. No. 11/454,814, filed Jul. 15, 2006, which is a continuation-in-part of U.S. patent application Ser. No. 10/857,043, filed May 28, 2004, entitled “Packaged Flavor Enhanced Fruits Or Vegetables Products With Extended Shelf-life For Mass Market Distribution And Consumption,” which claims the benefit of U.S. provisional patent application Ser. No. 60/699,460, filed Jul. 15, 2005, all of which are incorporated by reference herein.

### FIELD OF THE INVENTION

The present invention relates to enhancing the flavor of and packaging fruits or vegetables in a modified atmosphere positive pressure of CO₂. More particularly, the present invention relates to enhancing the flavor of fruits or vegetables within its own product packaging to extend the shelf-life and allow for mass production and mass distribution of the flavor enhanced fruits or vegetables, and the present invention relates to packaged flavor enhanced fruits or vegetables products produced by such methods.

### BACKGROUND OF THE INVENTION

The most popular snack foods have increasingly become heavily processed, pre-packaged for distribution, laden with preservatives to improve shelf-life, and inherently less nutritious than the traditional snack foods consumed in prior generations. Fresh fruits and vegetables continue to be replaced with pre-packaged snack foods that can be stored easily, served with minimal preparation, and, importantly, appeal to consumer tastes. These pre-packaged snack foods are often heavily processed with salts, sugars, and spices and consequently contribute to unhealthy dietary habits. Snack foods such as soft drinks, puffed corn products, fried potato chips, and other heavily processed items are routinely described as offering only empty calories to the consumer.

Perhaps the most widely consumed snack food considered to have little to no nutritional value is the soft drink. Carbonated soft drink beverages available today are made using syrups mixed with carbonated water. The syrups are commonly composed of a myriad of sweeteners (sugars or sugar substitutes), acids, preservatives, flavoring, and sometimes coloring for the final soft drink product. Sugar has been largely replaced by high fructose corn syrup, largely because it is less expensive and is somewhat sweeter, so less is needed. The artificial sweetener aspartame is a low-calorie sweetener and has largely replaced cyclamates and saccharin. The sweeteners neotame, acesulfame, and sucralose are sometimes used. Acids are added to soft drinks for extra bite and mouth feel. The primary acid used in colas, for example, is phosphoric acid. The primary acid used in citrus flavored drinks is typically citric acid. Carbonated water (carbonic acid, H₂CO₃) is also mildly acidic. Sodium benzoate is used as a broad spectrum antimicrobial, inhibiting bacteria, molds, and yeasts. The high acid content of the soft drink is necessary for the preservative action. Sodium citrate buffers the acids, so the pH stays low (more acidic). It also emulsifies any fats or fat-soluble compounds in the flavorings, keeping them in solution. Potassium sorbate is added to inhibit yeasts and fungi. Ascorbic acid (Vitamin C) may be used as an anti-oxidant. Colors are added to soft drink beverages to improve appeal. In colas, for example, the color comes from caramel coloring (or burnt sugar). Fruit flavored drinks such as orange soda use Red 40 and other colors.

Other snack foods such as puffed corn products, fried potato chips, and so on include a similarly daunting list of preservatives, additives, and non-nutritional ingredients. Snack foods with increased nutritional value and high consumer appeal are therefore very desirable. Efforts to develop an improved snack food include attempts to enhance the flavor of fruits or vegetables by exposing the fruits or vegetables to carbon dioxide (CO₂), thereby leaving the fruits or vegetables with an effervescent quality, or “fizzy” quality, due to the absorbed CO₂. If successful, the resulting carbonated fruits or vegetables would not only retain all their inherent nutritional value but also have added appeal and consumer excitement with the effervescent or “fizzy” character of the foods.

One method of producing carbonated fruits or vegetables has been described in U.S. Pat. No. 5,968,573 by Kaufman, entitled “Method for enhancing the flavor of fruits and vegetables.” The U.S. Patent 5,968,573 is hereby incorporated by reference. The method disclosed provides that the fruits or vegetables are processed in a scalable enclosure to establish the carbonating effect and then removed from the sealed CO₂ environment and covered to prevent the CO₂ from escaping from within the fruits or vegetables. However, testing establishes that this method can produce carbonated fruits or vegetables with effervescent qualities or “fizziness” lasting only long enough for immediate consumption. Once the fruits or vegetables are removed from the sealed CO₂ environment, the carbonation rapidly leaves the tissues of the fruits or vegetables. Testing shows that the carbonation can only be retained within the fruits or vegetables for several minutes. That is, the method is not capable of producing carbonated fruits or vegetables with sufficient shelf-life for mass market distribution or consumption. The method disclosed is not directed to solving the problems of extending shelf-life, methods to enhance the flavor of fruits or vegetables that yield products suitable for mass market distribution and consumption, and so forth.

The present invention particularly addresses these and other problems, as will be described in the detailed description herein, resulting in new packaged flavor enhanced fruits or vegetables products and methods for enhancing the flavor of fruits or vegetables within product packaging enabling mass market distribution and consumption of the new packaged products.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

For a more complete understanding of the present invention, the drawings herein illustrate examples of the invention. The drawings, however, do not limit the scope of the invention. Similar references in the drawings indicate similar elements.

FIG. 1 illustrates a method for enhancing the flavor of fruits or vegetables within its own product packaging according to one embodiment of the present invention.

FIG. 2 illustrates a packaged flavor enhanced fruits or vegetables product according to one embodiment.

FIG. 3 illustrates, in one embodiment, an exemplary method for enhancing the flavor of fruits or vegetables within its own product packaging, the method involving a port for receiving CO₂ into the product packaging.

FIG. 4 illustrates, in one embodiment, an exemplary packaged flavor enhanced fruits or vegetables product of the method illustrated in FIG. 3.

FIG. 5 illustrates a method for enhancing the flavor of fruits or vegetables within its own product packaging according to one embodiment of the present invention, the method involving a pressure chamber.

FIG. 6 illustrates one or more packaged flavor enhanced fruits or vegetables products within a pressure chamber according to the method illustrated in FIG. 5.

### DETAILED DESCRIPTION OF PREFERRED EMBODIMENT

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

Parts of the description will be presented using terminology commonly employed by those skilled in the art to convey the substance of their work to others skilled in the art. For example, a person having ordinary skill in the art will be able to comprehend terms such as modified atmosphere, carbon dioxide (CO₂), positive pressure, psi, carbonated, effervescent, carbonic acid, pasteurization, retort, heat sterilization, flash freezing, and so on in the context and intended meaning of the present invention and within the spirit and scope of the present invention.

The phrase “fruits or vegetables” is used herein to comprise any portion of: a single type of fruit, a mixture of different types of fruit, a single type of vegetable, a mixture of different types of vegetables, or a mixture of one or more types of fruit and one or more types of vegetable. As will be discussed further, “fruits or vegetables” also comprises any portion of pre-processed fruits or vegetables, such as, but not limited to, whole fruits or vegetables, pre-cut portions of fruits or vegetables, or any of a wide variety of processed or unprocessed fruits of vegetables having tissues with sufficient water content (suitable composition) that allows for absorption of CO₂. “Fruits or vegetables” may also comprise pieces of fruits or vegetables or sauces made from fruits or vegetables.

For example, the fruits or vegetables may be processed insofar as the fruits or vegetables are harvested and cut as is commonly practiced for a particular variety of fruits or vegetables. Peaches, for instance, may be pitted and skinned whereas seedless grapes may be left whole or left in bunches (including portions of the vine) as (grapes) are typically presented in grocery produce displays. Pieces of apples, for example, may be mixed with other fruit pieces (such as in a mixed fruit cocktail) or may be prepared as an apple sauce. Further, the fruits or vegetables may be finely cut, blended, crushed, or pureed. The fruits or vegetables may be pureed to a consistency suitable for consumption as a smoothly or similar beverage product. The resulting puree will contain all the flesh, pulp, fiber, and juice of the original fruits or vegetables product, but it will be consumable as a beverage product.

The term “smoothy” is used herein to generally describe a mixture of slush frozen pureed fruits or vegetables either alone or combined with milk, yogurt, another beverage or food product, and/or sweetened to taste, the smoothy having sufficient consistency to be consumed as a beverage.

Various terms may be used to qualitatively and quantitatively describe carbonation levels associated with food products. For example, a particular soft drink may contain three (3) volumes of CO₂, indicating that three (3) units of CO₂ have been dissolved (or forced) into each unit of the liquid drink. This particular example may represent, using different measurement terms, a CO₂ content level of approximately six (6) grams-per-liter. However, for purposes of describing the present invention it is more useful to describe the carbonation in terms of internal pressure (in pounds-per-square-inch or psi) of the CO₂ within the product packaging. For instance, the packaged flavor enhanced fruits or vegetables product may comprise product packaging with fruits or vegetables and a positive pressure of CO₂ wherein the positive pressure of CO₂ may he approximately 10 psi.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

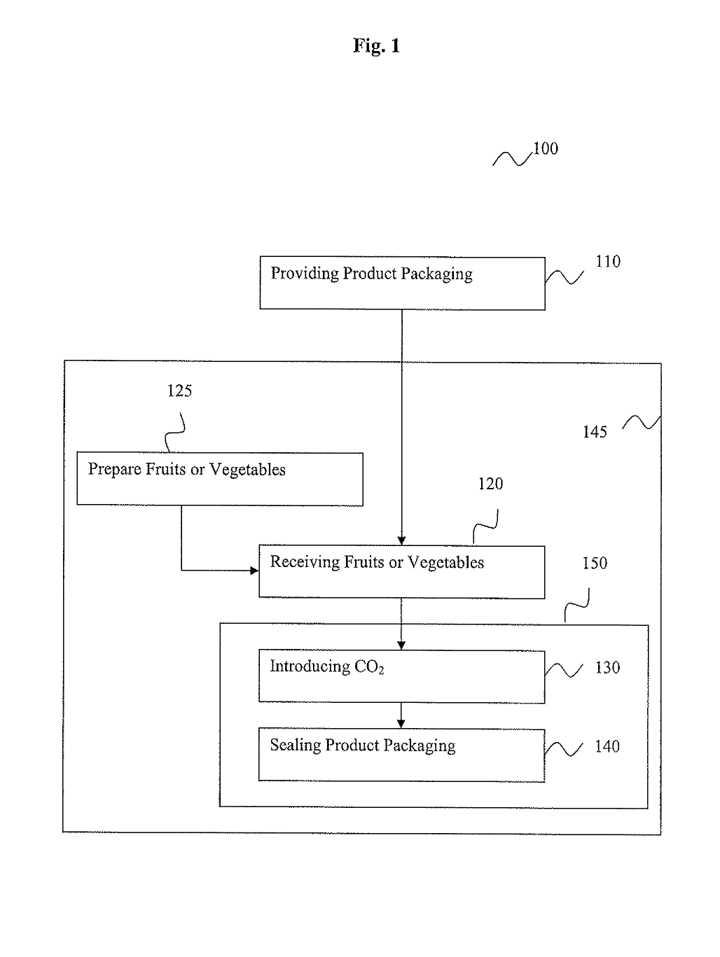

Turning now to FIG. 1, method steps 100, according to one embodiment of the present invention, are illustrated in a flow chart. As shown, method steps 100 comprise providing product packaging 110, receiving fruits or vegetables 120 into or at least proximate with the provided product packaging, before which the fruits or vegetables may have been prepared 125 (for example, as a sauce), introducing CO₂ 130 into or proximate with the product packaging containing or proximate with the fruits or vegetables, and sealing the production packaging 140 with the fruits or vegetables and CO₂ inside the product packaging.

Method steps 100 may further comprise one or more bactericidal methods 145 to reduce microbial growth and improve the shelf-life of the fruits or vegetables. The selected bactericidal method 145 may include any acceptable method of reducing microbial growth and depends upon the nature of the fruits or vegetables chosen, the intended food product to be produced, and other factors, and the selected bactericidal method 145 may be added in any order within the method steps 100. For illustrative purposes, a number of bactericidal methods are mentioned herein. For example, the bactericidal method 145 may comprise washing the fruits or vegetables in water or any of a number of sanitizers such as solutions containing chlorine, ozone, hydrogen peroxide, bromine, acids, and so on. The washed fruits or vegetables may then be prepared into a sauce (method step 125) and further packaged and carbonated according to the method steps 100. The bactericidal method 145 may comprise pasteurization. For example, a fruits or vegetables sauce may be batch or flash pasteurized to kill vegetative bacterial cells and various pathogens. Batch pasteurization typically involves elevating the temperature of the food product to 63-66 degrees Celsius for approximately 30 minutes whereas flash pasteurization typically involves elevating the temperature to around 72 degrees Celsius for approximately 15 seconds. Another bactericidal method 145 may involve elevating the temperature of the fruits or vegetables to approximately 121 degrees Celsius, raising the pressure to approximately 15 psi, and holding the temperature and pressure for around 15 minutes, effectively pressure cooking as the method of killing all forms of microorganisms as well as bacterial endospores. Yet another bactericidal method 145 may comprise utilizing a retort process. A typical retort process involves elevating the temperature of the food within the package it is to be sold in using superheated steam and holding the temperature for a predetermined period of time. For example, the sealed packaged flavor enhanced fruits or vegetables product from method step 140 may be placed in a retort process heating the product to approximately 125 degrees Celsius for up to 90 minutes. Still another bactericidal method 145 may comprise irradiation pasteurization or pulsed ultraviolet light exposure or other methods not mentioned herein.

The method steps 100 may further comprise freezing 150 the carbonated packaged fruits or vegetables thereby trapping the flavor enhancing CO₂ within the fruits or vegetables to produce a frozen carbonated fruits or vegetables product. In one embodiment, the freezing 150 step may be added to the method steps 100 as shown, as CO₂ is introduced 130, prior to sealing the product packaging 140, following sealing the product packaging 140, or simultaneous with introducing the CO₂ 130 and sealing the product packaging 140. Any of a wide variety of freezing processes may be used. In one embodiment, method steps 100 are performed in a refrigerated environment, and the temperature is reduced so that the packaged flavor enhanced fruits or vegetables become frozen after the introduced CO₂ has been absorbed by the fruits or vegetables, thus trapping the flavor enhancing CO₂ within the fruits or vegetables. In another embodiment, freezing 150 occurs following sealing flavor enhanced fruits or vegetables within its product packaging. Freezing 150 may be accomplished, for example, using readily available refrigeration and freezing equipment. Alternatively, freezing 150 may be accomplished using flash freezing techniques. Such flash freezing may involve liquid nitrogen or some other cryogenic agent which is safe for human consumption.

In one embodiment, providing product packaging 110 comprises providing a product packaging with at least one opening large enough for receiving the fruits or vegetables 120, thereafter CO₂ is introduced into the product packaging containing the fruits or vegetables (method step 130) and, finally, the product packaging is sealed (method step 140). In one embodiment, enough CO₂ is introduced and sealed within the product packaging containing the fruits or vegetables that there remains in the product packaging a positive pressure of CO₂. In one embodiment, this positive pressure is approximately 25 psi to 40 psi, sufficient pressure to thoroughly carbonate the fruits or vegetables therein. In another embodiment, the positive pressure is approximately 10 psi, enough to maintain desirable levels of carbonation within the fruits or vegetables wherein the fruits or vegetables may have been pre-carbonated prior to insertion into the product packaging. In various embodiments, the positive pressure of CO₂ may differ depending upon the desired “fizziness” of the fruits or vegetables.

In one embodiment, one or more of method steps 100 are performed in a refrigerated environment to minimize respiration of the fruits or vegetables and improve the absorption of CO₂ into the fruits or vegetables within the product packaging. In one embodiment, the fruits or vegetables are sealed in the product packaging with a 100% saturation level CO₂ environment within the product packaging containing the fruits or vegetables. In one embodiment, the fruits or vegetables are sealed in the product packaging with a carbon dioxide rich but less-than-100% carbon dioxide atmosphere. In one embodiment, the atmosphere within the sealed product packaging comprises enough pressurized gaseous carbon dioxide to allow carbon dioxide to be absorbed by the fruits or vegetables as well as a small amount of oxygen, just enough to prevent anaerobic conditions within the sealed produce packaging.

In one embodiment, the carbon dioxide rich atmosphere comprises around 95% to 99% carbon dioxide plus 1% to 5% oxygen. The atmosphere may comprise a majority of carbon dioxide (or enough pressurized carbon dioxide to allow absorption by the fruits or vegetables within the product packaging), a small amount of oxygen (or just enough to prevent anaerobic conditions within the product packaging), and other gases.

Method steps 100 may be accomplished using gas flushing or modified atmosphere packaging equipment, such equipment improved to allow for sealing the product packaging 140 such that the product packaging containing the fruits or vegetables is capable of retaining a positive internal pressure of CO₂. In one embodiment, the gas flush equipment directly introduces enough CO₂ into the product packaging containing the fruits or vegetables to achieve the positive pressure of CO₂. In an alternate embodiment, a source of CO₂ comprises the CO₂ introduced in step 130, and a positive pressure of CO₂ results from a release of CO₂ generated by a CO₂ generating material. In yet another embodiment, a source of CO₂ supplements the CO₂ introduced in step 130, and the source of CO₂ maintains the positive pressure of CO₂ introduced into the product packaging containing the fruits or vegetables (step 130).

Variations and alterations to method steps 100 may be made without disturbing the spirit and scope of the claimed method 100. Such variations and alterations may include, but are not limited to, rearranging the order of the steps 1003 adding sub-steps, and so on. In one embodiment, for example, method 100 comprises providing product packaging 110, receiving fruits or vegetables 120 into the product packaging, introducing CO₂ 130 by first evacuating all non-CO₂ gasses from the product packaging containing the fruits or vegetables and then introducing the CO₂ into the product packaging, and, finally, sealing the product packaging 140 containing the fruits or vegetables and CO₂ therein.

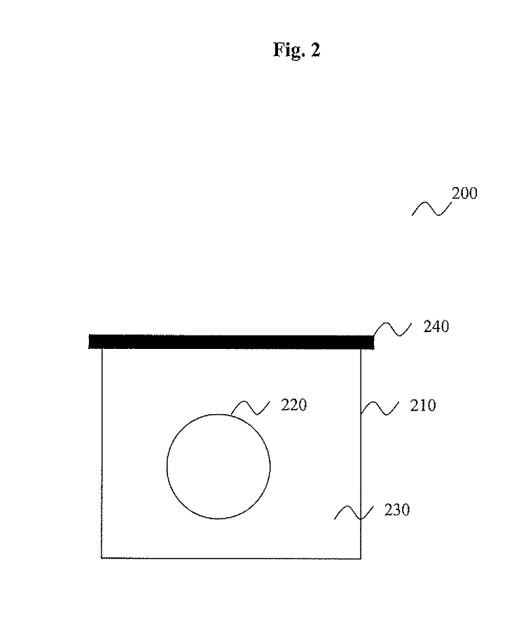

Next, FIG. 2 illustrates a packaged flavor enhanced fruits or vegetables product 200 produced using method steps 100, according to one embodiment of the present invention. As shown in FIG. 2, packaged flavor enhanced fruits or vegetables product 200 comprises product packaging 210 containing fruits or vegetables 220 and a positive pressure of CO₂ in the space 230 within product packaging 210. In one embodiment, packaged flavor enhanced fruits or vegetables product 200 further comprises a sealed area 240 into which the fruits or vegetables 220 were received and into which CO₂ was introduced into product packaging 210.

Product packaging 210 may comprise any number of a wide variety of commercially materials and shapes capable of retaining a positive pressure of CO₂ gas. For example, product packaging 210 may comprise a plastic cup and sealed area 240 may comprise a heat sealed material, the combination similar to containers used for packaging yogurts and other foodstuffs. In one embodiment, product packaging 210 comprises a plastic bag material, and sealed area 240 comprises a (heat, chemically, or ultrasonically) welded closure of the plastic bag material. In one embodiment, product packaging 210 comprises a metallic cup or bottle material such as aluminum or tin. In one embodiment, sealed area 240 comprises a pull-to-open type openable top similar to those used for a variety of foodstuffs such as puddings, fruit cocktails, and so on. Likewise, in one embodiment, product packaging 210 comprises a glass container with a suitable sealed area 240. Sealed area 240 may comprise any number of materials. In one embodiment, sealed area 240 comprises a screw-on or crimped metallic bottle-cap type top.

Product packaging 210 is not limited to the materials described herein. Any material that is capable of retaining a positive pressure of CO₂ may be used for product packaging 210 and sealed area 240. Also, product packaging 210 and sealed area 240 may comprise any shape or proportion. In one embodiment, product packaging 210 comprises two sheets of material, and sealed area 240 comprises a perimeter seal completely sealing the two sheets of material about fruits or vegetables 220 and retaining a positive pressure of CO₂ within the resulting packaged flavor enhanced fruits or vegetables product 200.

Product packaging 210 and sealed area 240 may comprise a darkened or opaque material to reduce or eliminate light intrusion upon fruits or vegetables 220, thereby reducing photosynthesis, respiration, or other processes and improving the shelf-life of packaged flavor enhanced fruits or vegetables product 200.

Regarding fruits or vegetables 220, as previously mentioned, any portion of a single fruit, medley of fruits, single vegetable, medley of vegetables, combination of fruits and vegetables, and so forth may be used. Any fruits or vegetables containing water may be carbonated to achieve a “fizzy” or effervescent quality. Different fruits and vegetables absorb CO₂ differently depending upon temperature, freshness of the fruits or vegetables, percentage water content, and so on. As a specific example, fruits or vegetables 220 may comprise apple sauce. Once packaged and flavor enhanced using method steps 100, the packaged flavor enhanced fruits or vegetables product 200 comprises packaged “fizzed” apple sauce, ready for mass market distribution and consumption.

Practicing the present invention to obtain packaged flavor enhanced fruits or vegetables products such as packaged flavor enhanced fruits or vegetables product 200 may comprise any processed or unprocessed fruits or vegetables, cut or uncut, mixed or unmixed, and so forth (as prepared in method step 125). As previously mentioned, fruits or vegetables 220 may include pureed fruits or vegetables, a sauce made from fruits or vegetables, or fruits or vegetables prepared in various other ways. For example, fruits or vegetables that have been fortified with vitamins, minerals, or other nutrients may comprise fruits or vegetables 220. Fruits or vegetables 220 may also comprise additional healthful ingredients such as, but not limited to, antioxidants, protein powders, and yogurt. Moreover, fruits or vegetables 220 may comprise fruits or vegetables that have been previously exposed to CO₂.

In various embodiments, the methods may further comprise adding one or more of the following to the fruits or vegetables prior to the step of sealing the product packaging: vitamins, nutrients, antioxidants, protein powders, milk, yogurt, ice cream, sorbet, and other foods. The fruits or vegetables 220 may also comprise fruit or vegetable pieces in yogurt, fruit or vegetable pieces in ice cream or sorbet, or other food items that may contain fruit or vegetable pieces, purees, sauces, and the like. Once packaged and flavor enhanced using method steps 100, the packaged flavor enhanced fruits or vegetables product 200 may comprise, for example, carbonated or “fizzed” fruit or vegetable pieces in yogurt, fruit or vegetable pieces in ice cream or sorbet, or other food items that may contain carbonated fruit or vegetable pieces, purees, sauces, and the like.

In one embodiment, FIG. 2 illustrates a packaged flavor enhanced food product 200 produced using method steps 100, according to one embodiment of the present invention. As shown, packaged food product 200 comprises product packaging 210 containing food product 220 and a positive pressure of CO₂ in the space 230 within product packaging 210. The packaged flavor enhanced food product 200 may further comprise a sealed area 240 into which the food product 220 was received and into which CO₂ was introduced into product packaging 210. The food product 200 may comprise, in various embodiments, carbonated or “fizzed” sauce made from fruits or vegetables, fruit or vegetable pieces in yogurt, fruit or vegetable pieces in ice cream or sorbet, or other food items that may contain carbonated fruit or vegetable pieces, purees, sauces, and the like.

Although the packaged food product 200 preferably comprises foods containing fruits or vegetables as previously described, the method steps 100 (and other methods described hereinafter) may be used with other foods instead of the fruits or vegetables 220. Other foods which are capable of absorbing carbon dioxide may be received into the product packaging 210 (in method step 120, for example). The packaged food product 200, for example, may comprise food items such as seafoods, meats, or other foods not classified (or described herein) as fruits or vegetables.

Still referring to FIG. 2, product packaging space 230, in one embodiment, comprises introduced CO₂. The introduced CO₂, in one embodiment comprises enough CO₂ so that there is a positive pressure of CO₂ retained in the packaged flavor enhanced fruits or vegetables product 200. In another embodiment, a CO₂ generating material may be introduced into space 230, the material generating enough CO₂ to maintain a positive pressure of CO₂ within product packaging 210 containing fruits or vegetables 220 and having sealed area 240 sealed. In one embodiment, the CO₂ generating material introduced into space 230 comprises dry ice. The CO₂ generating material introduced into space 230 may comprise a CO₂ releasing substance such as products commercially available from CO₂ Technologies™. The C₂ generating material introduced into space 230 may release enough CO₂ to create a positive pressure of CO₂ within space 230. In one embodiment, space 230 provides a 100% CO₂ saturation level environment for fruits or vegetables 220. In one embodiment, space 230 provides a carbon dioxide rich but less-than-100% carbon dioxide atmosphere. In one embodiment, the atmosphere within the sealed product packaging comprises enough pressurized gaseous carbon dioxide to allow carbon dioxide to be absorbed by the fruits or vegetables as well as a small amount of oxygen, just enough to prevent anaerobic conditions within the sealed product packaging.

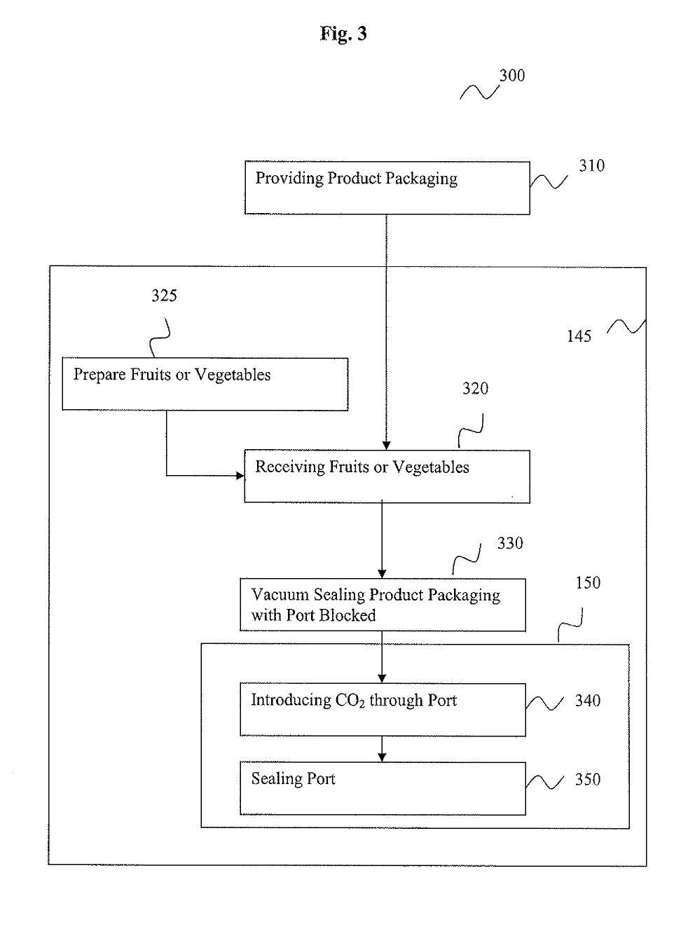

Moving now to FIG. 3, enhancing the flavor of fruits or vegetables within its product packaging comprises method steps 300, according to one embodiment. As shown, method steps 300 comprise providing product packaging 310, receiving fruits or vegetables 320, before which the fruits or vegetables may have been prepared 325 (for example, as a sauce), vacuum sealing the product packaging with a port blocked 330, introducing CO₂ through the port 340, and sealing the port 350. Method steps 300 may also comprise one or more bactericidal method 145 and freezing 150 as described previously.

In one embodiment, vacuum sealing the product packaging with a port blocked 330 comprises evacuation of non-CO₂ gasses from the product packaging containing the fruits or vegetables and then sealing the product packaging leaving an openable area (or port) through which CO₂ may be introduced into the product packaging. In one embodiment, the port is blocked to prevent gaseous flow through the port and to thereby favorably assist the evacuation of non-CO₂ gasses from the product packaging containing the fruits or vegetables.

According to one embodiment, introducing CO₂ through the port 340 comprises flowing enough CO₂ through the port (or opening) into the product packaging containing the fruits or vegetables to create a positive pressure of CO₂ within the product packaging. In one embodiment, this positive pressure is approximately 25 psi to 40 psi, sufficient pressure to thoroughly carbonate the fruits or vegetables therein. In another embodiment, the positive pressure is approximately 10 psi, enough to maintain desirable levels of carbonation within the fruits or vegetables wherein the fruits or vegetables may have been pre-carbonated prior to insertion into the product packaging. In various embodiments, the positive pressure of CO₂ may differ depending upon the desired “fizziness” of the fruits or vegetables.

In one embodiment, one or more of method steps 300 are performed in a refrigerated environment to minimize respiration of the fruits or vegetables and improve the absorption of CO₂ into the fruits or vegetables within the product packaging. In one embodiment, the fruits or vegetables are sealed in the product packaging with a 100% saturation level CO₂ environment within the product packaging containing the fruits or vegetables. In one embodiment, the fruits or vegetables are sealed in the product packaging with a carbon dioxide rich but less-than-100% carbon dioxide atmosphere having a small amount of oxygen to prevent anaerobic conditions within the sealed product packaging.

In an alternate embodiment, a source of CO₂ comprises the CO₂ introduced in step 340, and a positive pressure of CO₂ results from a release of CO₂ generated by a CO₂ generating material. In yet another embodiment, a source of CO₂ supplements the CO₂ introduced in step 340 and the source Of CO₂ maintains the positive pressure of CO₂ introduced into the product packaging containing the fruits or vegetables (step 340).

In one embodiment, sealing the port 350 comprises closing the port (or opening) resulting in a packaged flavor enhanced fruits or vegetables product suitable for mass distribution and consumption. As will be discussed, the port may comprise any opening through which CO₂ may be introduced (method step 340). It follows, therefore, that sealing the port 350 may involve different processes depending upon the material properties and functional properties of the port. For example, if the port comprises an opening held closed but not sealed in method step 330, subsequently sealing the port 350 may comprise a similar scaling process as in step 330 but without the vacuum aspect.

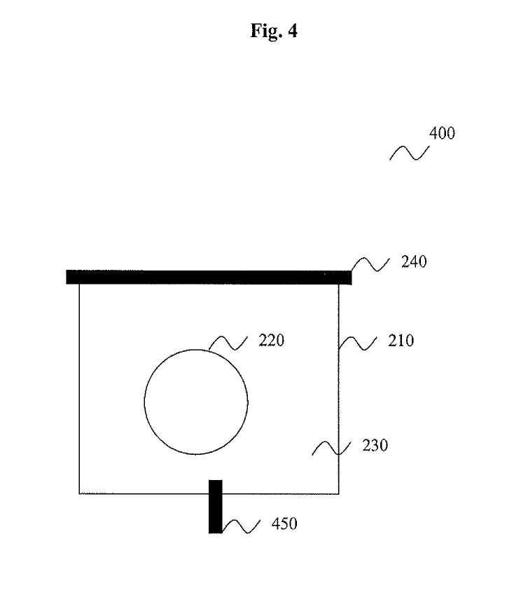

Referring now to FIG. 4, a packaged flavor enhanced fruits or vegetables product 400 produced using method steps 300 is illustrated, according to one embodiment of the present invention. As shown in FIG. 4, packaged flavor enhanced fruits or vegetables product 400, in one embodiment, comprises the packaged flavor enhanced fruits or vegetables product 200 with port 450 added. In one embodiment, port 350 comprises a portion of sealed area 240 left open for introducing CO₂ through the opening (method step 340). In one embodiment, port 350 comprises a one-way check valve capable of permitting CO₂ to flow into space 230 and retaining a positive pressure of CO₂ therein. In another embodiment, port 350 comprises a sealable plastic tube at least large enough to allow the flowing CO₂ into space 230. In one embodiment, port 450 comprises a plastic tube sealable using commercially available (heat, chemical, or sonic) welding equipment. Methods for sealing port 450 are well known in the art and need not be described in further detail. Likewise, one skilled in the art will be able to substitute a wide variety of materials, configurations, and devices comprising port 450.

In one embodiment, the port 450 comprise a one-way valve which allows a gas (such as carbon dioxide) to flow one way (such as into) the product packaging 210. Using a one-way valve, according to one embodiment, eliminates the step of sealing the port 450 (step 350). The one-way valve 450 may comprise a thinly layered plastic or foil device having an inlet on one side and deformable characteristics on the other side such that a gas may flow through the inlet when the deformable side deflects in one direction (in response to a pressure gradient applied in that direction) and is trapped on the other side when the deformable side deflects in a second direction (in response to a pressure gradient applied in the second direction). Other types of one-way valves may be used.

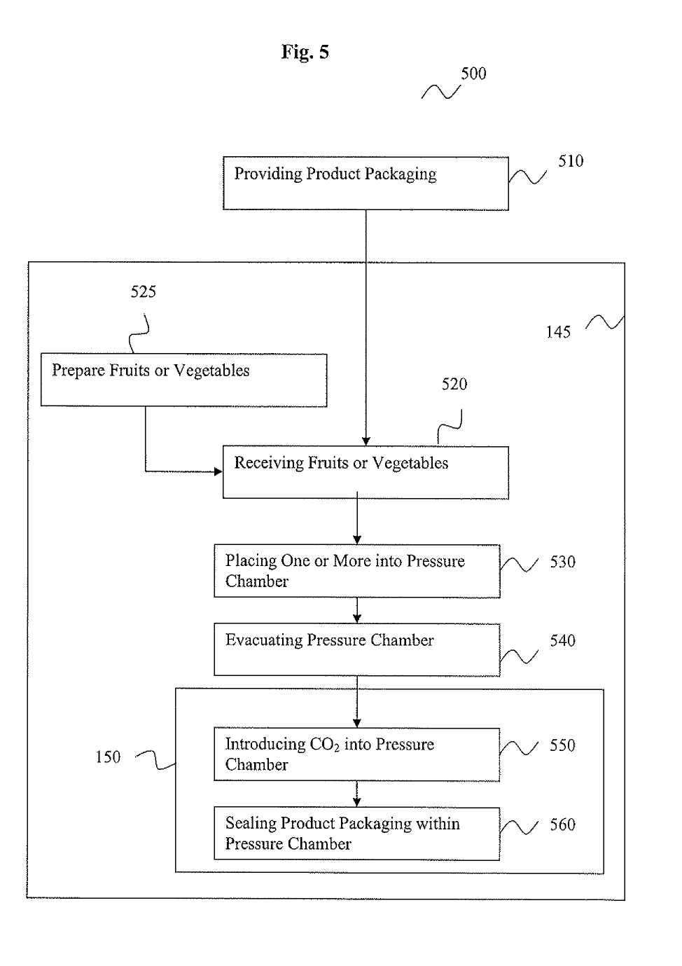

Next, FIG. 5 illustrates method steps 500 for producing one or more packaged flavor enhanced fruits or vegetables product using a pressure chamber. As shown, method 500 comprises providing product packaging 510, receiving fruits or vegetables into the product packaging 520, before which the fruits or vegetables may have been prepared 525 (for example, as a sauce), placing one or more of the product packaging containing fruits or vegetables into a pressure chamber 530, evacuating non-CO₂ gasses from the pressure chamber 540, introducing CO₂ into the pressure chamber 550, and sealing the one or more product packaging containing fruits or vegetables within the pressure chamber 560. Method steps 500 may also comprise one or more bactericidal method 145 and freezing 150 as described previously.

In one embodiment, placing one or more of the product packaging (step 530) comprises placing one or more of the product packaging as in FIG. 2 into a pressure chamber. In one embodiment, placing one or more of the product packaging (step 530) comprises placing one or more of the product packaging as in FIG. 4 into a pressure chamber.

According to one embodiment introducing CO₂ into the pressure chamber 550 comprises flowing enough CO₂ into the pressure chamber to create a positive pressure of CO₂ within the product packaging therein. In one embodiment, this positive pressure is approximately 25 psi to 40 psi, sufficient pressure to thoroughly carbonate the fruits or vegetables therein. In another embodiment, the positive pressure is approximately 10 psi, enough to maintain desirable levels of carbonation within the fruits or vegetables wherein the fruits or vegetables may have been pre-carbonated prior to insertion into the product packaging. In various embodiments, the positive pressure of CO₂ may differ depending upon the desired “fizziness” of the fruits or vegetables.

In one embodiment, one or more of method steps 500 are performed in a refrigerated environment to minimize respiration of the fruits or vegetables and improve the absorption of CO₂ into the fruits or vegetables within the product packaging. In one embodiment, within the pressure chamber, the fruits or vegetables are sealed in the product packaging with a 100% saturation level CO₂ environment within the product packaging containing the fruits or vegetables. In one embodiment, within the pressure chamber, the fruits or vegetables are sealed in the product packaging with a carbon dioxide rich but less-than-100% carbon dioxide atmosphere. In one embodiment, the atmosphere within the sealed product packaging comprises enough pressurized gaseous carbon dioxide to allow carbon dioxide to be absorbed by the fruits or vegetables as well as a small amount of oxygen, just enough to prevent anaerobic conditions within the sealed product packaging.

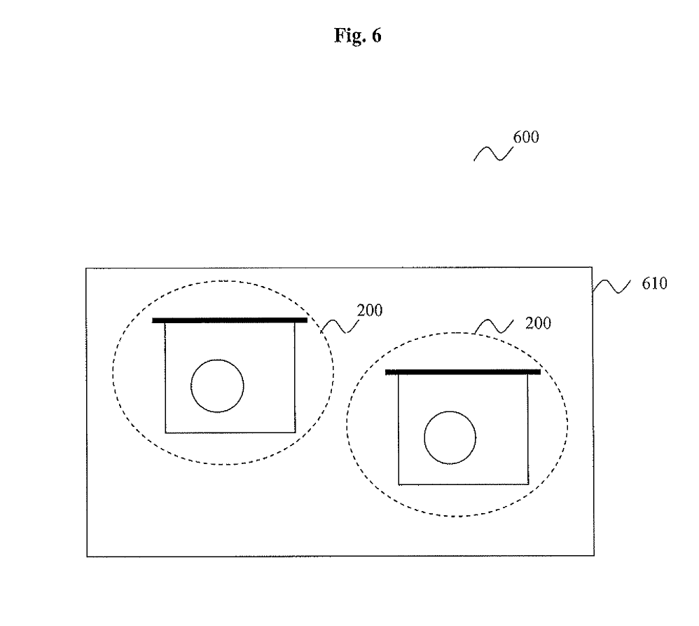

FIG. 6 illustrates one or more packaged flavor enhanced fruits or vegetables product within a pressure chamber according to the method illustrated in FIG. 5. As shown in FIG. 6, pressure chamber 610 contains one or more packaged flavor enhanced fruits or vegetables product 200. Pressure chamber 610 may be used as shown, with product packaging as in FIG. 2, or with product packaging as in FIG. 4, or with other variations of product packaging as described previously.

In one embodiment, introducing CO₂ into pressure chamber (method step 550) comprises flowing enough CO₂ into pressure chamber 610 so as to create a positive pressure of CO₂. As the pressure of CO₂ becomes positive in pressure chamber 610, the pressure of CO₂ within product 200 also becomes positive since the CO₂ is able to freely enter the unsealed product packaging 210. Likewise, as the pressure of CO₂ becomes positive in pressure chamber 610, in one embodiment, the pressure of CO₂ within product 400 contained inside pressure chamber 610 becomes positive since the CO₂ is able to freely enter port 450. In one embodiment, subsequent to introducing enough CO₂ to achieve a positive pressure of CO₂ within the product packaging containing the fruits or vegetables the product packaging is sealed, thereby resulting in one or more packaged flavor enhanced fruits or vegetables product such as product 200 or product 400. The methods described herein may be scaled up for high volume production of packaged flavor enhanced fruits or vegetables. In one embodiment, pressure chamber 610 is capable of operating on a large number of products such as product 200.

As described herein, the present invention provides methods for enhancing the flavor of fruits or vegetables within its own product packaging to extend the shelf-life and allow for mass production and mass distribution of the flavor enhanced fruits or vegetables, and the present invention provides packaged flavor enhanced fruits or vegetables products produced by such methods. The methods comprise providing product packaging capable of retaining a positive pressure of CO₂, receiving fruits or vegetables into the product packaging, introducing CO₂ into the product packaging, and sealing the product packaging containing the fruits or vegetables and CO₂, and wherein the product packaging retains a positive pressure of CO₂, and the fruits or vegetables absorb the CO₂ thereby enhancing the flavor of the fruits or vegetables within the product packaging.

Although a person having skill in the art may comprehend alterations and modifications of the present invention after having read the foregoing description, it is to be understood that the particular embodiments shown and described by way of illustration are in no way intended to be considered limiting. References to details of particular embodiments are not intended to limit the scope of the claims. Rather, it will be appreciated that many variations, modifications, and embodiments are possible, and all such variations, modifications, and embodiments are to be regarded as being within the spirit and scope of the invention.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A method of enhancing the flavor of fruits or vegetables within its own product packaging to extend the shelf-life and allow for mass production and mass distribution of the flavor enhanced fruits or vegetables, the method comprising:
providing product packaging capable of retaining a positive pressure of CO₂, receiving fruits or vegetables into said product packaging, introducing CO₂ into said product packaging, and sealing said product packaging containing said fruits or vegetables and said CO₂, wherein said product packaging retains said positive pressure of CO₂, and said fruits or vegetables absorb said CO₂ thereby enhancing the flavor of said fruits or vegetables within said product packaging.

2. The method of claim 1, wherein said introducing CO₂ into said product packaging comprises creating a 100% CO₂ saturation environment for said fruits or vegetables or creating a carbon dioxide rich but less-than-100% carbon dioxide saturation environment with just enough oxygen to prevent anaerobic conditions within said product packaging.

3. The method of claim 1, further comprising evacuating non-CO₂ gases from said product packaging prior to said introducing CO₂ into said product packaging.

4. The method of claim 1, wherein said introducing CO₂ into said product packaging comprises adding enough CO₂ into said product packaging to establish said positive pressure of CO₂ within said product packaging.

5. The method of claim 4, wherein said positive pressure of CO₂ comprises a positive pressure of between 25 psi and 40 psi.

6. The method of claim 1, wherein said introducing CO₂ into said product packaging comprises inserting a CO₂ generating material into said product packaging, wherein said CO₂ generating material dispenses CO₂ within said product packaging and generates enough CO₂ to establish said positive pressure of CO₂ within said product packaging.

7. The method of claim 1, wherein said introducing CO₂ into said product packaging comprises inserting a source of CO₂ into said product packaging, said source of CO₂ comprising dry ice.

8. The method of claim 1, further comprising adding one or more of the following to said fruit, or vegetables prior to said step of sealing: vitamins, nutrients, antioxidants, protein powders, milk, yogurt, ice cream, sorbet, and other foods.

9. The method of claim 1, wherein said steps of introducing CO₂ into said product packaging and sealing said product packaging containing said fruits or vegetables and said CO₂ comprise the steps of:
vacuum sealing said product packaging containing said fruits or vegetables leaving a port area that may be opened and large enough for flowing CO₂ into said product packaging containing said fruits or vegetables, introducing CO₂ into said product packaging through said port, and sealing said port.

10. The method of claim 1, wherein said steps of introducing CO₂ into said product packaging and sealing said product packaging containing said fruits or vegetables and said CO₂ comprise the steps of:
introducing CO₂ into said product packaging through a one-way valve disposed on said product packaging so that said CO₂ flows into said product packaging and becomes trapped therein, wherein said one-way valve is capable of retaining a positive pressure atmosphere within said product packaging.

11. The method of claim 1, wherein said steps of introducing CO₂ into said product packaging and sealing said product packaging containing said fruits or vegetables and said CO₂ comprise the steps of;
placing one or more said product packaging containing said fruits or vegetables into a pressure chamber,
evacuating said pressure chamber to remove non-CO₂ gases,
introducing CO₂ into said pressure chamber, and
sealing said one or more product packaging containing said fruits or vegetables within said pressure chamber.

12. The method of claim 1, wherein said fruits or vegetables comprise minimally processed cut fruits or vegetables, fruits or vegetables cut into pieces, crushed fruits or vegetables, or fruits or vegetables further prepared as purees or sauces.

13. A packaged flavor enhanced fruits or vegetables product produced according to the method comprising:
providing product packaging capable of retaining a positive pressure of CO₂,
receiving fruits or vegetables into said product packaging,
introducing CO₂ into said product packaging, and
sealing said product packaging containing said fruits or vegetables and said CO₂, wherein said product packaging retains said positive pressure of CO₂, and said fruits or vegetables absorb said CO₂ thereby enhancing the flavor of said fruits or vegetables within said product packaging.

14. The product of claim 13, wherein said introducing CO₂ into said product packaging comprises creating a 100% CO₂ saturation environment for said fruits or vegetables or creating a carbon dioxide rich but less-than-100% carbon dioxide saturation environment with just enough oxygen to prevent anaerobic conditions within said product packaging.

15. The product of claim 13, wherein said introducing CO₂ into said product packaging comprises adding enough CO₂ into said product packaging to establish said positive pressure of CO₂ within said product packaging.

16. The product of claim 15, wherein said positive pressure of CO₂ comprises a positive pressure of between 25 psi and 40 psi.

17. The product of claim 13, wherein said introducing CO₂ into said product packaging comprises inserting a CO₂ generating material into said product packaging, wherein said CO₂ generating material dispenses CO₂ within said product packaging and generates enough CO₂ to establish said positive pressure of CO₂ within said product packaging.

18. The product of claim 13, wherein said introducing CO₂ into said product packaging comprises inserting a source of CO₂ into said product packaging, said source of CO₂ Comprising dry ice.

19. The product of claim 13, further comprising adding one or more of the following to said fruits or vegetables prior to said step of sealing: vitamins, nutrients, antioxidants, protein powders, milk, yogurt, ice cream, sorbet, and other foods.

20. The product of claim 13, wherein said steps of introducing CO₂ into said product packaging and sealing said product packaging containing said fruits or vegetables and said CO₂ comprise the steps of:
vacuum sealing said product packaging containing said fruits or vegetables leaving a port area that may be opened and large enough for flowing CO₂ into said product packaging containing said fruits or vegetables,
introducing CO₂ into said product packaging through said port, and
sealing said port.

21. The product of claim 13, wherein said steps of introducing CO₂ into said product packaging and sealing said product packaging containing said fruits or vegetables and said CO₂ comprise the steps of:
introducing CO₂ into said product packaging through a one-way valve disposed on said product packaging so that said CO₂ flows into said product packaging and becomes trapped therein, wherein said one-way valve is capable of retaining a positive pressure atmosphere within said product packaging.

22. The product of claim 13, wherein said fruits or vegetables comprise minimally processed cut fruits or vegetables, fruits or vegetables cut into pieces, crushed fruits or vegetables, or fruits or vegetables further prepared as purees or sauces.

23. A packaged flavor enhanced food product, comprising product packaging sized to sealably enclose a portion of a food item and capable of holding a positive pressure of a carbon dioxide rich atmosphere surrounding said food item, said food item having tissues with sufficient water content to absorb at least some of said carbon dioxide, said absorbed carbon dioxide enhancing the flavor of said food item so that said food item acquires an effervescent or “fizzy” quality.

24. The packaged flavor enhanced food product of claim 23, wherein said food item comprises foods containing fruits or vegetables prepared as pieces, sauces, or purees.

25. The packaged flavor enhanced food product of claim 23, wherein said food item comprises apple sauce.

26. The packaged flavor enhanced food product of claim 23, wherein said food item comprises fruits or vegetables pieces mixed with yogurt, ice cream, sorbet, or other foods.

27. The packaged flavor enhanced food product of claim 23, wherein said food item comprises seafoods, meats, or other foods not classified as fruits or vegetables.
